(19) United States
(12) Patent Application Publication
(10) Pub. No.: US 2026/0001083 A1
(43) Pub. Date: Jan. 1, 2026

(54) DEVICE FOR MONITORING OPERATIONAL CONDITIONS OF A MINERAL CRUSHER

(71) Applicant: Viwek VAIDYA, Beaconsfield (CA)

(72) Inventor: Viwek VAIDYA, Beaconsfield (CA)

(21) Appl. No.: 19/252,116

(22) Filed: Jun. 27, 2025

Related U.S. Application Data
(60) Provisional application No. 63/664,927, filed on Jun. 27, 2024.

(51) Int. Cl. B02C 25/00; B02C 19/00

(52) U.S. Cl. CPC B02C 25/00; B02C 19/005

(57) ABSTRACT

There is disclosed a mill comprising a motorized rotating drum having an internal cavity of the rotary drum; a lifter and grinding media located in the internal cavity for promoting breakdown of mineral; a bolt configured to hold the lifter to the inner surface of the rotary drum, one end of the bolt elongated to the full height of the lifter located in the internal cavity of the rotary drum, the other end of the elongated bolt located outside of the rotary drum; an acoustic sensor acoustically coupled to the elongated bolt for capturing acoustic waves carried by the bolt from the inside to the outside of the internal cavity; and a condition monitoring system mounted on the rotating drum communicating data to a base station. AI assisted condition monitoring of the acoustic signals, provides control parameters for safe operation of the mill, optimizing lifter wear and through put.

### CROSS REFERENCE

The present application claims priority to U.S. Provisional Patent Application No. 63/664,927, filed on Jun. 27, 2024, and entitled “DEVICE FOR MONITORING OPERATIONAL CONDITIONS OF A MINERAL CRUSHER”, the entirety of which incorporated by reference herein.

### TECHNICAL FIELD

The present disclosure relates to the field of non-destructive testing. More specifically, the present disclosure relates to methods, systems and devices for monitoring operational properties of the mineral crusher and triggering one or more actions based on the operational properties.

### BACKGROUND

Mineral crushers, such as autonomous grinding (AG) mills, semi-autonomous grinding (SAG) mills and other types of mills, are commonly used in mining and other industries to grind and crush ore material. The material to be crushed is introduced in a generally cylindrical, rotating drum having on its internal faces a number of lifters, which are usually made of steel or rubber or hybrid. As the drum rotates, the ore material and the grinding media are lifted by the lifters and fall onto each other, creating impact and attrition forces that break down the ore into finer particles.

The crushed material then exits the mill through a discharge grate at the bottom of the drum. The speed and load of the mill can be adjusted to control the size distribution and quality of the final product. SAG mills are often used as the primary stage of grinding, followed by a secondary stage of ball mills or pebble mills.

Maintenance of SAG mills often requires operational downtime which may be costly. Therefore, there is a need for improvements in measurement techniques for detecting SAG mill operational parameters that do not necessarily require operational downtime.

### SUMMARY

The foregoing and other features will become more apparent upon reading of the following non-restrictive description of illustrative embodiments thereof, given by way of example only with reference to the accompanying drawings.

### BRIEF DESCRIPTION OF THE DRAWINGS

A better understanding of the embodiments of the present technology (including alternatives and/or variations thereof) may be obtained with reference to the detailed description of the nonlimiting embodiments along with the following drawings, in which:

FIG. 1 is a side elevation view of a SAG mill in accordance with non-limiting embodiments of the present technology.

FIG. 2 is a perspective view of an elongated bolt in accordance with non-limiting embodiments of the present technology.

FIG. 3 is a cross-sectional side view of a wear monitoring device supporting a rubber lifter mounted in the rotating drum of the SAG mill in accordance with non-limiting embodiments of the present technology.

FIG. 4 is a cross-sectional front view of the wear monitoring device supporting a steel lifter mounted in the rotating drum of the SAG mill in accordance with non-limiting embodiments of the present technology.

FIG. 5 is a schematic representation of how the acoustic sensor captures an audio signal in accordance with non-limiting embodiments of the present technology.

FIG. 6 shows a cross-section of the rotating drum 14 taken along line A-A on FIG. 1.

FIG. 7 depicts a processing pipeline of an acoustic signal captured by the acoustic sensor in accordance with non-limiting embodiments of the present technology.

FIG. 8 is an electrical diagram of a system for monitoring waves of a mineral crusher in accordance with non-limiting embodiments of the present technology.

FIG. 9 is a sequence diagram showing operations of a method of assembling the wear monitoring device on the mineral crusher in accordance with non-limiting embodiments of the present technology.

FIG. 10 depicts a schematic cross-section of the mill of FIG. 1.

FIG. 11 depicts an onboard device in accordance with non-limiting embodiments of the present technology.

FIG. 12 depicts another embodiment of the elongated bolt of FIG. 2 in accordance with non-limiting embodiments of the present technology.

### DETAILED DESCRIPTION

Various aspects of the present disclosure generally address one or more of the problems related to the fragility and the lack of precision of conventional measurement techniques for wear on lifters.

Generally speaking, the present technology relates to the monitoring of operational parameters for mineral crushers such as autonomous grinding (AG) mills and semi-autogenous grinding (SAG) mills.

In some embodiments, there is provided a system for monitoring one or more of the following operational parameters:
SAG mill output in tons per hour;
Mill rotational speed;
Volume of the charge;
Weight of the charge in the mill;
% solids in the charge;
Ore size at entry and hardness of the ore;
Output ore size distribution at mill exit;
Weight of grinding media per hour;
Weight of water entering the mill per hour;
Weight of ore entering the mill per hour;
Position of the charge, toe and shoulder of ore;
Position of the charge, toe and shoulder of the grinding media;
Lifter erosion due to direct metal on metal hits;
Grinding efficiency and power draw, Kw/ton; and
Grinding efficiency and residual lifter height.

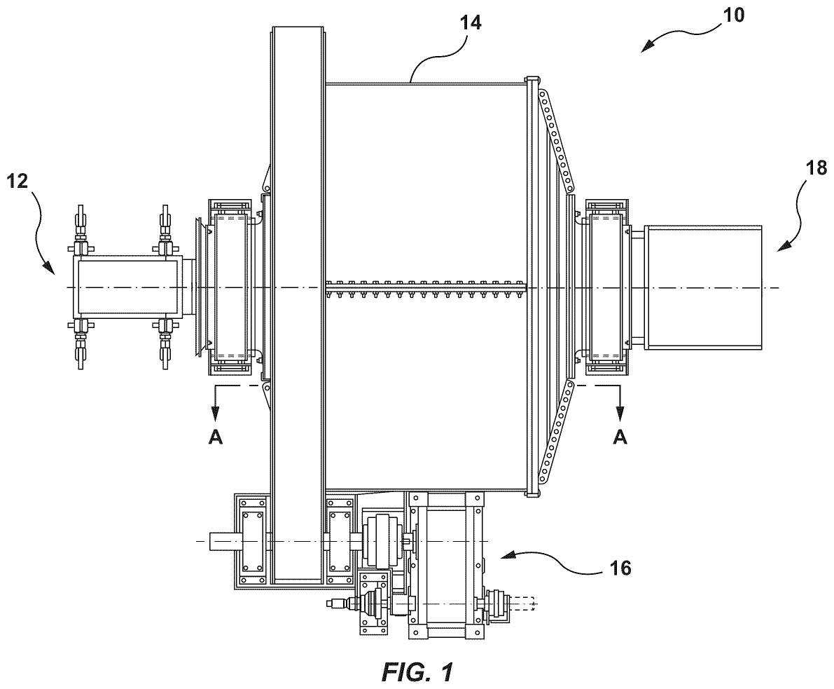

FIG. 1 is a side elevation view of a SAG mill. Material to be crushed is inserted in a SAG mill 10 via a feed end 12 and reaches an internal cavity of a rotating drum 14. A motor and drive combination 16 causes the rotating drum 14 to rotate. A number of lifters, are disposed along the internal periphery of the rotating drum 14. As the rotating drum 14 rotates, pieces of the material and grinding media, such as steel balls, contained in the rotating drum 14 tumble over the lifters and collide with each other, breaking into smaller pieces. The material eventually exits from the rotating drum 14 at a discharge end 18 of the SAG mill 10.

While the mill starts rotating, a charge, which refers to pieces of the material and grinding media, moves and finds an equilibrium position for optimised mill operation. The ore is introduced from the entry end and exits continuously from the exit end. The lifters (e.g., 2 ton castings attached within the mill-hard 600 BHN) within the mill, lift the ore and the grinding media, (e.g., 5 inch dia hard 600 BHN steel balls) grind the ore while the ore is crushed between the ejected balls and the lifters on the opposite side.

Developers have realized that downtime of the mill for a gold mine can be anywhere from $30,000 to $50,000/hour.

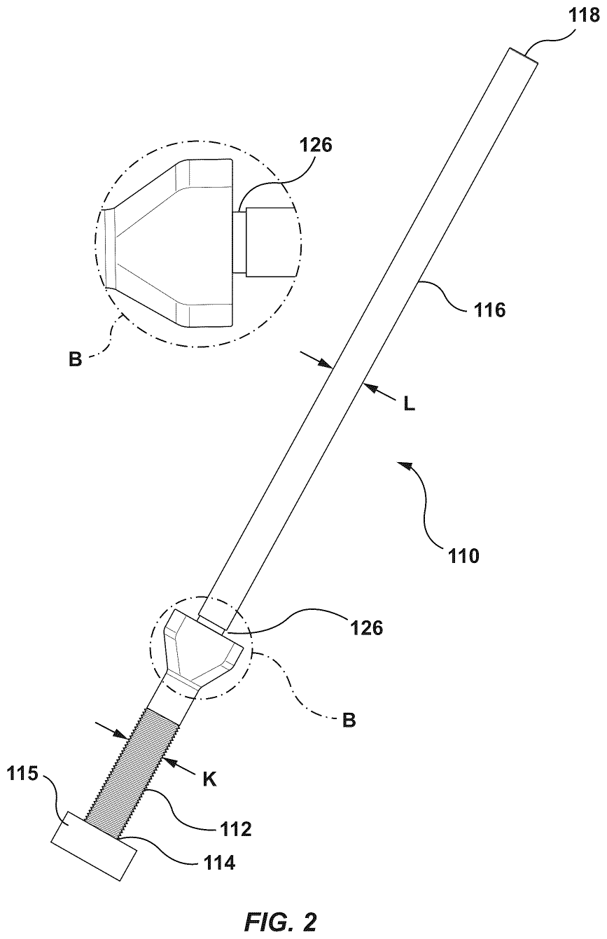

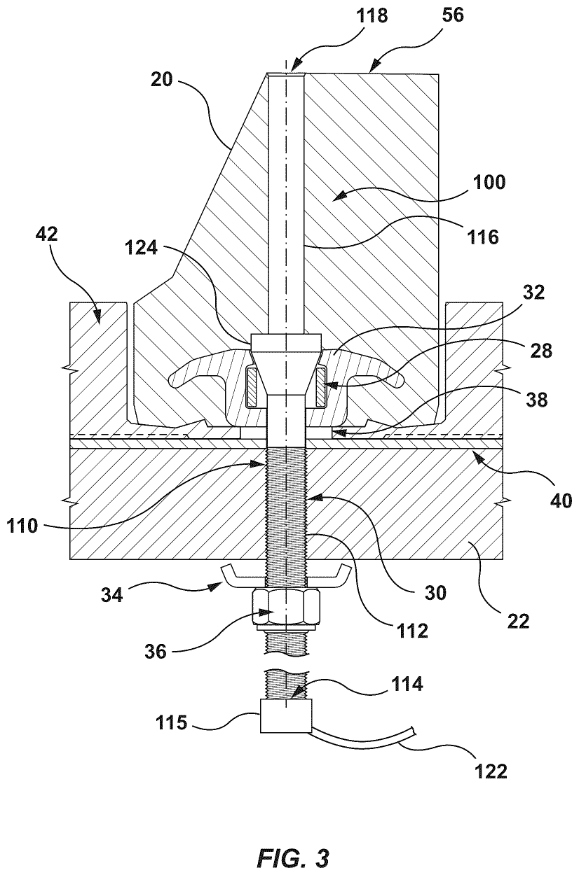

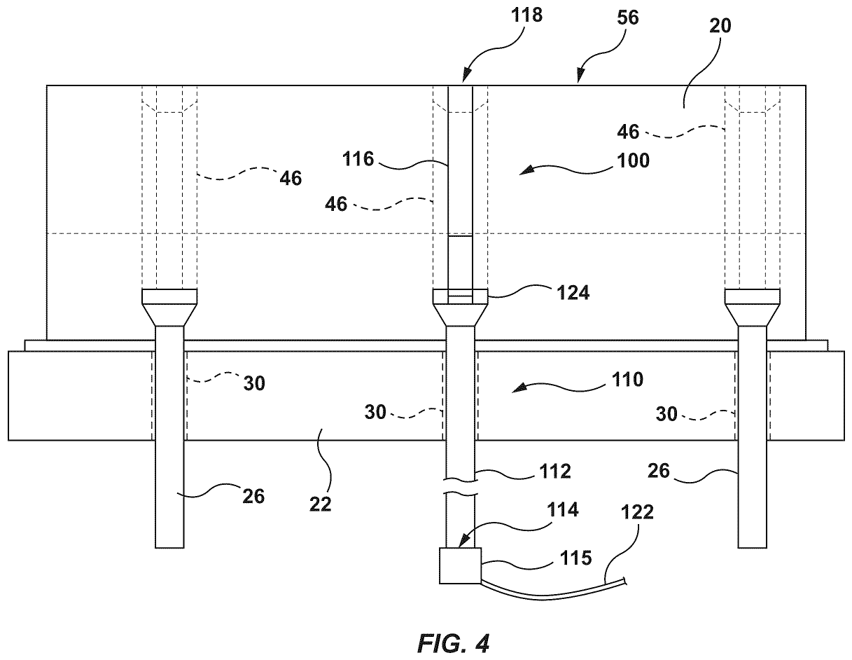

FIG. 2 is a perspective view of an elongated bolt according to an embodiment of the present disclosure. FIG. 3 is a cross-sectional side view of a wear monitoring device supporting a rubber lifter mounted in the rotating drum of the SAG mill according to an embodiment of the present disclosure. FIG. 4 is a cross-sectional front view of the wear monitoring device supporting a steel lifter mounted in the rotating drum of the SAG mill according to an embodiment of the present disclosure.

Referring to FIGS. 2, 3 and 4, a system 100 is adapted for monitoring various operational parameters of the SAG mill 10. The system 100 includes an elongated bolt 110, an acoustic sensor 115. The elongated bolt 110 is useable for maintaining the lifter 20 in place on an internal face of the SAG mill 10.

In some embodiments, the system 100 may further comprise a transducer, without departing from the scope of the present technology. In these embodiments, the transducer may be similar to the transducer disclosed in the U.S. Pat. No. 11,782,029, entitled “Device and system for monitoring wear of a wearable component mounted in mining equipment”, filed on Dec. 2, 2020, and the contents of which is incorporated herein by reference in its entirety.

In these embodiments, an electromagnetic acoustic transducer (EMAT) may also be coupled to an end of the elongated bolt 110. The EMAT may be adapted to inter alia (i) generate a sound wave within the proximal end of the elongated bolt 110, (ii) detect an echo of the sound wave reflected by the distal end of the elongated bolt 110, and (iii) report to a controller a time delay between the generation of the sound wave and the detection of the echo. The controller is configured to determine, based on the time delay between the generation of the sound wave and the detection of the echo, a residual length of the elongated bolt 110.

It should be noted that the residual length of the elongated bolt 110 can be used to evaluate the wear of the elongated bolt 110. However, in some embodiments of the present technology, the system 110 may make use of the residual length of the elongated bolt 110 for processing one or more audio signals captured by the acoustic sensor 115. For example, determination of one or more operational parameters of the mill based on the signal (e.g., audio signals or other vibrational signals) may further depend on inter alia a current residual length of the elongated bolt 110 when the audio signal has been captured. As a result, the EMAT may be used to determine a current residual length of the elongated bolt 110, then the acoustic sensor 115 may be configured to capture a signal transmitted by the elongated bolt, and the one or more operation parameters of the mill may be predicted based on both the signal and the then current residual length of the elongated bolt 110.

Developers of the present technology have realized that the audio signal may be used to capture information indicative of “direct hits” of grinding media on the extended bolt 110 and this information may be correlated to the then residual length of the bolt 110 using the EMAT.

### Elongated Bolt

The elongated bolt 110 includes a threaded section 112 that terminates at a proximal end 114 of the elongated bolt 110. At least a part of the threaded section 112 including the proximal end 114 protrudes beyond an outer surface of the SAG mill 10 through a hole 30 pierced on the internal face and through the steel shell 22 of the SAG mill 10. A nut 36 is tightened on the threaded section 112 for maintaining the elongated bolt 110 in place. The elongated bolt 110 also comprises a shank 116 terminating at a distal end 118 of the elongated bolt 110 opposite from the proximal end 114.

A length of the shank 116 extends to the full height 56 of the lifter 20. The distal end 118 of the elongated bolt 110 is adapted to wear at a rate equivalent to a rate of wear of the lifter 20 when the SAG mill 10 is in operation.

In an embodiment, the threaded section 112 of the elongated bolt 110 has a diameter ‘K’ and the shank 116 of the elongated bolt 110 has a diameter ‘L’ that is equal to or less than the diameter ‘K’. In the same or another embodiment, the elongated bolt 110 is made of steel. Use of other materials that can is also contemplated.

FIG. 3 shows that the steel channel 28, the aluminum extrusion 32, the cup washer 34, the support 38, the rubber gasket 40 and the rubber packing 42 may also be part of the assembly of the lifter 20 and of the elongated bolt 110 on the SAG mill 10.

FIG. 4 shows an example of an application in which a lifter 20 is maintained by a centrally positioned elongated bolt 110 and by two laterally positioned bolts 26 inserted through openings 46 in the lifter 20. FIG. 4 is only one of many possible configurations, as a plurality of systems 100 may be used to monitor the wear of a given lifter 20. Also, the SAG mill 10 having a plurality of lifters 20 mounted in its rotating drum 14, one or more systems 100 may be mounted on all or on a subset of the lifters 20 of the SAG mill 10, without departing from the scope of the present technology.

As shown on FIGS. 2, 3 and 4, the elongated bolt 110 may further comprises a shoulder 124 at a junction of the threaded section 112 and of the shank 116. The shoulder 124 is configured to prevent a relative movement between the elongated bolt 110 and the lifter 20 when assembled. The shoulder 124 may for example have an oblong shape. In an embodiment, the threaded section 112 and the shoulder 124 are forged in one piece and the shank 116 is connected to the shoulder 124 by friction welding, a joint 126 between the shank 116 and the shoulder 124 being visible in detail B of FIG. 2. Friction welding assists in ensuring that ultrasonic signal may be transmitted between the shank 116 and the shoulder 124 without obstruction. It is contemplated that the elongated bolt 110 may be configured differently, while still being configured to effectively allow ultrasonic signal transmission therethrough. For example, in some embodiments, the bolt may be a forged elongated bolt.

In some embodiments, the elongated bolt may be a forged elongated bolt. In other embodiments, the elongated bolt may be manufactured by precision casting and/or additive manufacturing technology with desired metallurgical compositions and properties to suite a given service application.

### Acoustic Sensor

The acoustic sensor 115 is coupled to the proximal end 114 of the elongated bolt 110. The acoustic sensor 115 is directly connected to the elongated bolt 110. The acoustic sensor 115 is directly connected to the elongated bolt 110 in order to capture vibrations of the elongated bolt 110 during operation of the mill 10 and generate an audio signal representative of the vibrations. As will be described in greater detail below, the acoustic sensor 115 is configured to transmit said signal(s) (e.g., audio signals) to a controller 200. In one embodiment, the acoustic sensor 115 may be configured to capture signals within a hearing range from 20 Hz to 20,000 Hz.

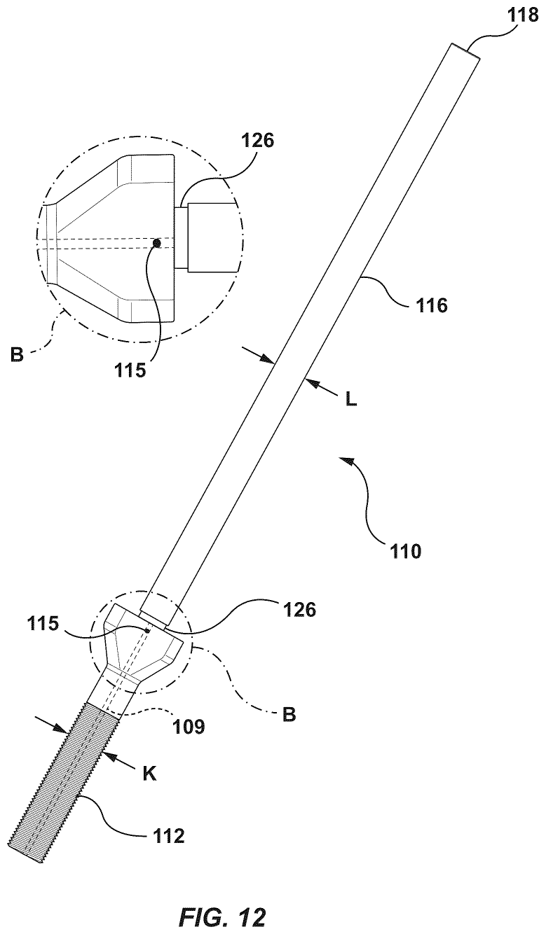

Referring briefly to FIG. 12, in some embodiments, instead of being coupled to the proximal end 114, it is contemplated that the acoustic sensor 115 is embedded within the elongated bolt 110. How the acoustic sensor 115 is embedded within the elongated bolt 110 is not limited. For example, on a standard bolt, a concentric passage 109 is created by subtractive manufacturing. The bolt is then elongated to create the elongated bolt 110 by additive manufacturing. The acoustic sensor 115, such as a microphone, can be installed in the concentric passage 109, so as to monitor the sound coming from within the cavity of the SAG mill to detect metal on metal impacts or other relevant sound signatures for machine learning (described in detail below). In some embodiments, it is contemplated to insert a AE sensor (which are generally larger than microphones) within the elongated bolt instead of the microphone, provided that it fits a larger concentric passage 109 that does not affect the structural integrity of the bolt.

In at least one embodiment of the present technology, the acoustic sensor 115 may be embodied as an audio sensor capturing audio signals coming from within the rotary drum.

In some embodiments, the acoustic sensor 115 may be configured to measure Acoustic Emissions (AE). Broadly, AE is defined as the rapid release of energy in the form of a transient elastic stress wave generated by an acoustic source that can be detected and recorded by AE instrumentation in frequency ranges of 20 KHz to 1 MHz. Developers have realized that AE monitoring may be used to detect in real-time, direct hits between the grinding media and elongated bolt 110 and provide residual elongated bolt 110 lengths after calibration.

In some embodiments, the Neural Network (NN) may be configured to perform normalization and a variety of statistical analyses to identify clusters within the data that have similar parameters. In at least some embodiments, the NN may be configured to classify AE signals of the acoustic sensor 115 into differences classes of AE signals.

In those embodiments where the acoustic sensor 115 is embodied as an AE sensor, the frequency range of acoustic emission signals may be between 20,000 Hz to 1 MHz.

In some embodiments where the acoustic sensor 115 is embodied as a UT sensor and/or as a phased array ultrasonic testing (PAUT) sensor, the frequency range of the sensor could be between 1 MHz to 10 MHz.

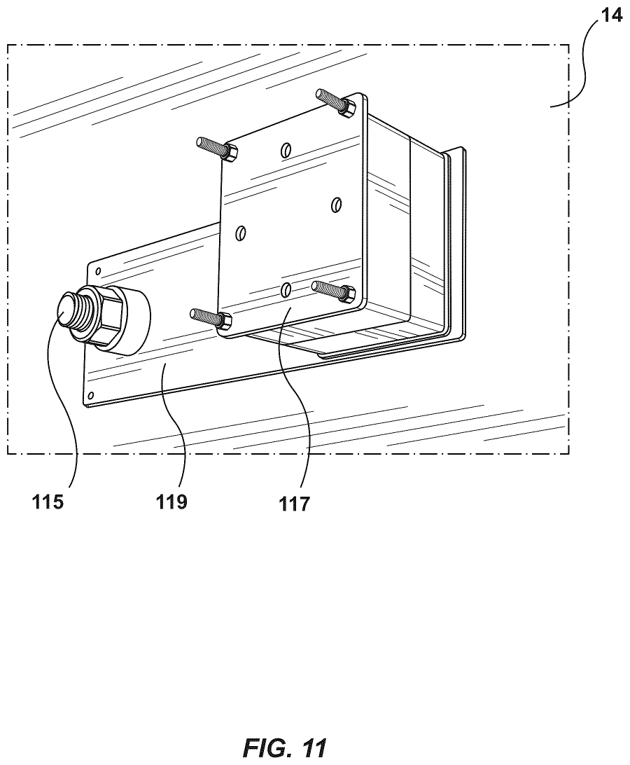

In some embodiments, the acoustic sensor 115 may be part of an onboard device, such as the onboard device of FIG. 11. The onboard device to be coupled to an exterior wall of the drum 14, and includes a sensor mounting plate 119 attached to the exterior wall, and a sensor holding plate 117. The acoustic sensor 115 can be held in place on the centerline of the elongated bolt 110, sandwiched between the sensor mounting plate 119 and the sensor holding plate 117. The onboard device may include, in addition to the acoustic sensor 115, a video or proximity sensor, battery, a wireless module/monitoring system with antenna and a charger. The charger may be a kinetic charger or a solar charger. In some embodiments, the onboard device may be installed on a lifter bolt outside of the mill 10.

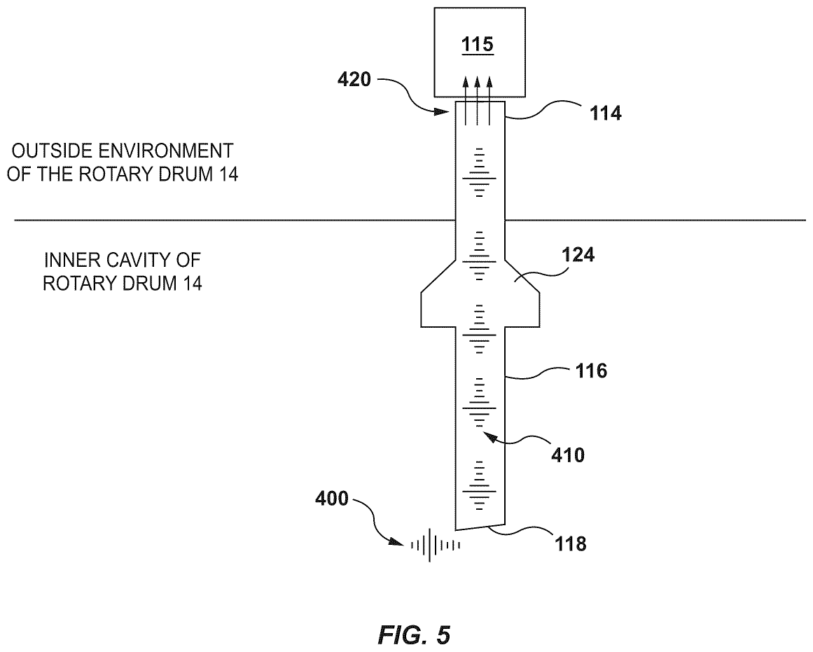

The acoustic sensor 115 is a transducer that is configured to pick up audio signals from within the SAG mill 10 via the elongated bolt 110. With reference to FIG. 5, there is depicted a schematic representation of how the acoustic sensor 115 captures an audio signal. During operation of the mill 10, sound waves 400 are generated inside the drum 14. The sound waves 400 cause the elongated bolt 110 to vibrate and sound waves 410 propagate through the elongated bolt 110. The acoustic sensor 115 connected to the elongated bolt 110 captures audio waves 420.

Developers of the present technology have realized that connecting the acoustic sensor 115 directly onto the bolt 110 to capture audio waves propagated by the elongated bolt 110 may be better suited for determining one or more operational parameters of the mill 10. For example, in contrast to an acoustic sensor configured to capture audio waves from the environment around the drum 14, the acoustic sensor 115 captures audio waves that are emitted from the inside of the drum 14 and transmitted to the acoustic sensor 115 via the elongated bolt 110. It is contemplated that the audio waves emitted from the inside of the drum 14 and transmitted to the acoustic sensor 115 via the elongated bolt 110 may carry less noise than audio waves in the outer environment of the drum 14.

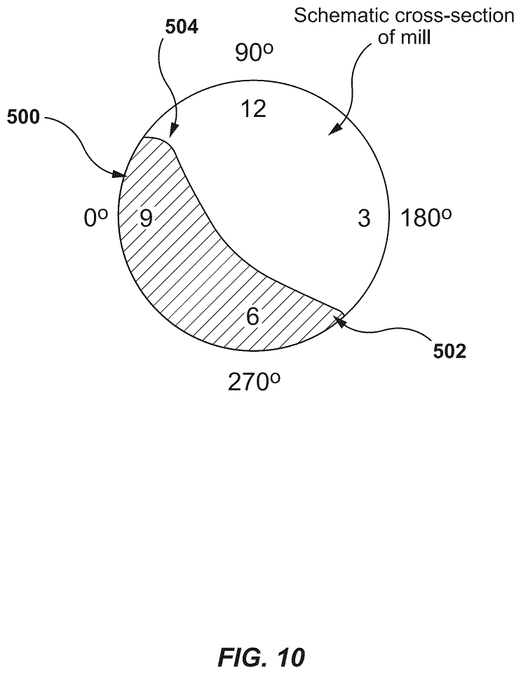

By analyzing data from a single acoustic sensor 115, or by analyzing data from a plurality of acoustic sensors, various operation parameters can be determined. With reference to FIG. 10, the following may be determined by analyzing the audio signals: determining a position of the charge 500 within the SAG mill 10, identifying a position of a charge toe 502 within the SAG mill 10 and/or of a position of a charge shoulder 504 within the SAG mill 10. In some instances, a two-dimensional visual display depicting the position of the charge 500 may be produced using the audio signals.

Over time, as the various acoustic sensors 115 monitors audio signals from within the SAG mill 10, the controller 200 may be configured to determine sound signatures, determine operating benchmarks and/or sound patterns.

The acoustic sensor 115 can be configured as an audio sensor to sense and/or record audio signals at various instances throughout the milling process. For example, the acoustic sensor 115 can be configured to pick up audio signals as the SAG mill 10 starts up, as the SAG mill 10 reaches steady state, as ore is added within the SAG mill 10, as grinding media is added within the SAG mill 10, and/or as water is added within the SAG mill 10. While the SAG mill 10 is operating in a steady state condition, the controller 200 may be configured to determine an “optimal sound signature”. The artificial intelligence module then can analyze the data to determine, optimum conditions, residual lifter heights and alarms for metal-on-metal impacts.

After establishing benchmark signatures, the controller 200 may be configured to sound an alarm when unusual sound signatures occur. In some instances, this can assist in limiting premature wear of components by identifying problematic situations, so that they can be fixed earlier (e.g., identify conditions where grinding media hits lifters). For example, when recording audio signals corresponding to low humming (generated by motors and gears), metallic clinking (generated by steel balls colliding with ore particles) or steading grinding noise (as the mill crushes and grinds the material), the controller 200 may recognize the SAG mill is working well. When the audio signals correspond to excessive vibrations (may be generated by misalignment of parts, worn parts or loose components), loud screeching or grinding (may be generated by generated by damaged gears or inadequate lubrication), or inconsistent noise patterns, the controller 200 may recognize that the SAG mill 10 is having problems.

In some embodiments, the acoustic sensor 115 and the controller 200 could be configured to continuously monitor audio signals. In other embodiments, the acoustic sensor 115 and the controller 200 may be configured to monitor on demand.

It is contemplated that in some embodiments, additional acoustic sensors may be positioned outside of the SAG mill. It will be appreciated that the audio signal picked up by the acoustic sensors 115 can provide better readings than other sensors that are not directly connected to elongated bolts extending inside the drum 14.

It will be appreciated that the system 100 can assist in enhancing efficiency of the SAG mill 10 by monitoring various aspects such as in coming ore size, volumetric fill, grinding media trajectory, real time direct hits between the grinding media and the mill shell or lifters (which is impacted by liner profile and mill RPM), ore properties (size and hardness), charge 500 and density, and adjusting these various aspects to operate the SAG mill 10 in optimal conditions. The adjustment may be done automatically by the controller 200, or may be performed manually by an operator, following an indication provided by the controller 200.

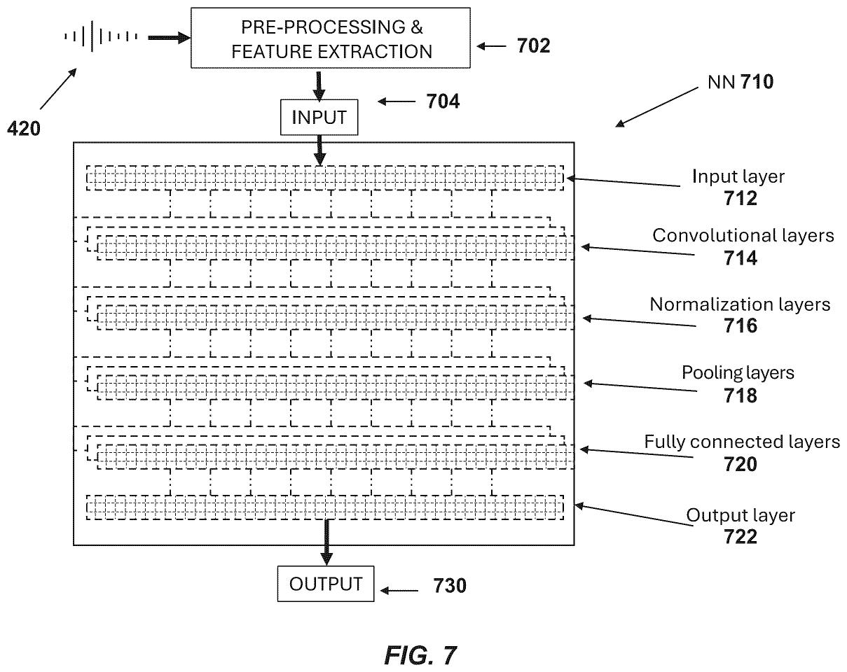

The audio signals captured by the acoustic sensor 115 may be further processed to determine one or more operational parameters of the mill 10. With reference to FIG. 7, there is depicted a processing pipeline of an audio signal captured by the acoustic sensor 115.

A processor may be configured to apply one or more pre-processing and/or feature extraction steps on the audio signal 420. The audio signals, which may be referred to as sound waves or sound frequencies, may be analyzed via spectral analysis to identify specific frequencies. In one example, a Fast Fourier Transform (FFT) algorithm may be used for the spectral analysis of the audio signal 420.

In some embodiments, the processor may apply one or more techniques disclosed in “Acoustic Sensing and Supervised Machine Learning for In Situ Classification of Semi-Autogenous (SAG) Mill Feed Size Fractions Using Different Feature Extraction Techniques” authored by Owusu et al, published on Apr. 11, 2023, the contents of which is incorporated herein by reference in its entirety.

### Machine Learning Algorithms

Generally speaking, Machine Learning Algorithms (MLAs) are computational models that make predictions or decisions based on data, learning patterns and relationships within the data to improve performance over time. These algorithms fall into three main categories: supervised learning models, unsupervised learning models, and reinforcement learning models.

Supervised learning algorithms are trained on labeled data, where the output is known, to make predictions and/or classifications. Decision trees model use a tree-like structure, providing clear and interpretable results. Support Vector Machines (SVM) find the hyperplane that best separates different classes in the data, and Neural Networks (NNs), inspired by the human brain, are highly effective for complex tasks like image and speech recognition.

Unsupervised learning algorithms use unlabeled data, aiming to uncover hidden patterns or intrinsic structures within the dataset. K-Means Clustering groups data into clusters based on similarity, useful in segmentation tasks, for example. Hierarchical Clustering builds a tree of clusters, showing data relationships at various levels. Principal Component Analysis (PCA) reduces the dimensionality of data while preserving variance, often used in data compression and visualization. Association rules identify relationships between variables in large datasets, commonly applied in market basket analysis to find product associations.

Reinforcement learning algorithms represent an agent learning to make decisions by interacting with an environment to maximize cumulative reward. Q-Learning, a value-based approach, finds the optimal action-selection policy. Deep Q-Networks (DQN) combine Q-learning with Deep Neural Networks (DNNs), enhancing the agent's ability to handle complex, high-dimensional environments. Policy Gradient Methods directly optimize the policy by adjusting parameters to maximize expected reward.

In at least one embodiment of the present technology, an audio signal, a pre-processed audio signal, and/or one or more features extracted from an audio signal may be provided by the processor as an input to a MLA.

### Convolutional Neural Network

With reference to FIG. 7, in one embodiment of the present technology, the MLA may be implemented as a NN 710. In some embodiments, the NN 710 may be a Convolutional Neural Network (CNN). Broadly, a CNN is a deep learning model designed to automatically and adaptively learn spatial hierarchies of features through a backpropagation algorithm. CNNs can be applied to audio analysis and classification problems by leveraging their ability to analyze patterns in 2D data, such as spectrograms for example.

To utilize CNNs for audio processing, audio data can be transformed into image-like representations. This transformation allows the CNN to analyze the patterns and features within the audio data effectively. Commonly used audio features that can be represented as images include Mel Frequency Cepstral Coefficients (MFCCs), Mel Spectrograms, and Chromagrams. MFCCs represent the short-term power spectrum of a sound signal and are derived from the Fourier transform, Mel-scale filter bank, and Discrete Cosine Transform (DCT). Mel Spectrograms, on the other hand, use a Mel scale to convert frequencies into perceptually meaningful Mel-frequency bins, providing a time-frequency representation of audio. Chromagrams map the frequency content of audio onto the twelve semitones of the Western musical scale, representing pitch classes in a visual format.

The CNN 710 comprises several layers for feature extraction and data processing. An input layer 712 accepts the audio features transformed into image-like formats, such as MFCCs, Mel Spectrograms, or Chromagrams. This layer prepares the data for subsequent processing by the network.

One set of layers in the CNN are convolutional layers 714, which apply convolution operations to the input data using a set of learnable filters (kernels). Each filter slides across the input, performing element-wise multiplication and summing the results to produce feature maps. This process enables the model to learn local patterns within the data.

Convolutional layers can have various configurations. The convolutional layers 714 may have a number of filters for determining the number of feature maps produced by the layer. More filters allow the network to capture a greater variety of features. The convolutional layers 714 may have a filter size which are the dimensions of the filter (e.g., 3×3 or 5×5). Smaller filters capture fine details, while larger filters capture more global patterns. The convolutional layers 714 may have stride which is the step size with which the filter moves across the input. A larger stride reduces the spatial dimensions of the output feature map. The convolutional layers 714 may have padding for adding extra border pixels to the input to control the spatial size of the output feature maps. Following each convolutional layer, activation functions may be used to introduce non-linearity into the model. This non-linearity allows the CNN to learn complex patterns in the data. Activation functions include: Rectified Linear Units (ReLUs), sigmoids and tanhs.

An other set of layers in the CNN 710 are pooling layers 716. Pooling layers, such as Max Pooling or Average Pooling, reduce the spatial dimensions of the feature maps while retaining essential information. By summarizing the presence of features and providing translational invariance, pooling layers help reduce computational load and control overfitting. Key components of pooling layers include the pool size, which is the size of the window used to perform the pooling operation (e.g., 2×2), and a stride, which is the step size with which the pooling window moves across the feature map.

An other set of layers in the CNN 710 are normalization layers 718. Normalization layers, such as batch normalization, may be included to normalize the output of the previous activation layer. Batch normalization accelerates training and stabilizes the learning process by reducing internal covariate shift. This is achieved by subtracting the batch mean and dividing by the batch standard deviation.

Another set of layers in the CNN 710 are fully-connected layers 720. Fully-connected layers integrate features extracted by convolutional and pooling layers to perform classification or regression tasks. Each neuron in a fully connected layer receives input from all neurons in the previous layer, enabling the model to learn complex representations. Key aspects of fully connected layers include: weights and biases, which are parameters that are learned during training, and activation function such as ReLU, Sigmoid, and Softmax (for multi-class classification).

The CNN 710 includes an output layer 722 which produces the final prediction of the model, whether it be a probability distribution over classes for multi-class classification tasks (using softmax activation) or a probability value for binary classification tasks (using sigmoid activation). For regression tasks, a linear activation function is typically used.

In one embodiment, the input layer 712 may acquire information indicative of audio features pre-processed and/or extracted from the audio signal 420. In some embodiments, the input layers may receive one or more of a MFCCs, Mel Spectrograms, or Chromagrams. The convolutional layers 714 may apply filters to detect one or more features in the audio data. Activation Functions can be applied after each or some of the convolutional layers 714 to introduce non-linearity. The pooling layers 718 may be used to reduce the dimensions of the feature maps while retaining important information. The normalization layers 716 may be optional layers to normalize the outputs of activation layers. The fully-connected layers 720 may be used to integrate features from convolutional and pooling layers to learn high-level representations. The output layer may produce the final classification or regression result, depending on the task.

In at least some embodiments of the present technology, the processor may use a signal, a pre-processed signal, and/or one or more features extracted from a signal as input into the CNN 710 configured to generate an output 730 indicative of one or more operational parameters of the mill 10 to be monitored. In some embodiments, the one or more signals processed and/or inputted into the CNN 710 may comprise audio signals. In at least some embodiments, the processor may be configured to monitor the one or more operational parameters of the mill 10 and in response trigger one or more actions. In some embodiments, the one or more actions triggered by the processor may include remedial actions and/or controlling operation of the mill 10. The desired optimised output 730 is based on all of the above operating parameters of para 0022, which will provide load optimization, real time feedback to the operator, reducing mill liner wear, reducing grinding media consumption while improving milling circuit efficiency and optimizing power draw per ton of ore crushed.

For example, with an optimized fill volume of the mill, containing ore, grinding media and water and the mill is operating at the correct output (tons per hour), several operating conditions may prevail. If the mill rotates too fast, then the grinding media (steel balls) will hit the shell above the 502 regions on FIG. 10. This sound signature is easy to recognize and must be avoided. The rotational speed if reduced, the balls now fall at an optimum angle crushing the ore between the balls and the lifters attached to the inner surface of the mill at location 502 on the FIG. 10. This state is the optimised state, with maximum grinding efficiency and the sound signature is what is desired. If the mill speed is further reduced, the balls fall below the 502 regions, with its own unique sound signature. This operating condition produces poor grinding efficiency so the corrective action can be to speed up the mill or change the ratio of water and ore content in the mill or several other parameters that MLA can provide for corrective action.

Operating parameters can be controlled using vibration analysis as shown by FLSmidth and Molycop, neither use extended bolts to process their vibrational and/or audio signals. Coupling the acoustic sensor 115 directly on the proximal end of the extended bolt holding the lifters, provides a clearer signal to the AI module for machine learning the activity within the mill.

### Electronic Device

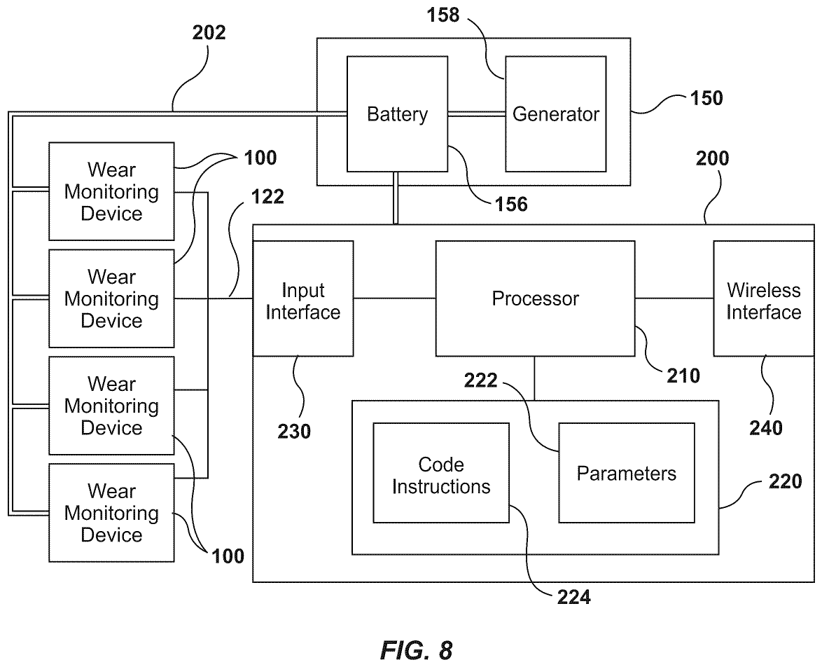

FIG. 8 is an electrical diagram of a system for monitoring waves of a mineral crusher according to an embodiment of the present disclosure. In some embodiments, the system may be implemented for monitoring audio waves. The system comprises the earlier mentioned controller 200 and a plurality of the systems 100. The controller 200 comprises a processor or a plurality of cooperating processors (represented as a processor 210 for simplicity), a memory device or a plurality of memory devices (represented as a memory device 220 for simplicity), an input interface or a plurality of input interfaces (represented as an input interface 230 for simplicity) receiving time delay information from the systems 100, and a wireless communication interface 240. The wireless communication interface 240 may, for example and without limitation, support WiFi, Bluetooth™, 4G and/or 5G transmission technologies or low-power wide area Spidermesh technology, using a wireless radio protocol The processor 210 is operatively connected to the memory device 220, to the input interface 230 and to the wireless communication interface 240. The memory device 220 includes a storage 222 for storing parameters, including for example frequencies and time periods for the controller 200 to control operation of the systems 100. The memory device 220 may also comprise a non-transitory computer-readable medium 224 for storing instructions that are executable by the processor 210.

The controller 200, and more specifically the input interface 230, is connected via the signaling wire 122 or via a plurality of signaling wires 122 to the acoustic sensor 115 of each system 100. In an embodiment, the acoustic sensor 115 of each system 100 provides an electronic identification to the controller 200, allowing the controller 200 to identify each system 100 based on the provided electronic identification. In a non-limiting example, two systems 100 mounted on a same lifter 20 may be connected to the controller 200 via a common signaling wire 122.

The controller 200 and the systems 100 are each connected to the power supply 150 via electric wires 202. In an embodiment, the controller 200 and the power supply 150 may be proximally located on the external face 152 of the rotating drum 14, allowing bundling of some of the electric wires 202 with the signaling wire or wires 122.

In operation, the controller 200 receives a given time delay from any given system 100 connected via the signaling wire or wires 122. The processor 210 may be configured to process signals captured by the system 100. In some embodiments, the processor 210 may be configured to process audio signals captured by the system 100.

### a Plurality of Vibration Monitoring Systems

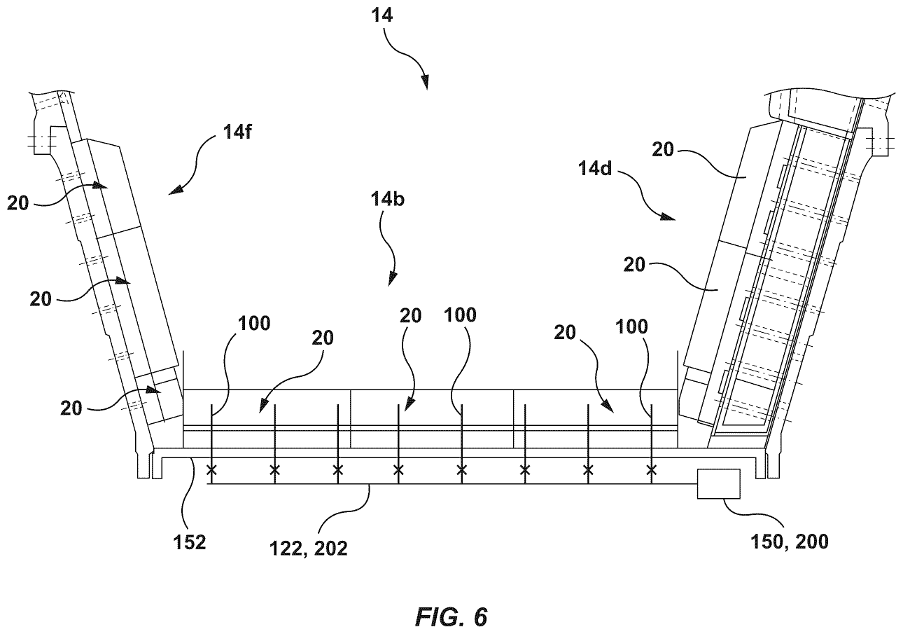

FIG. 6 is an example of a configuration of a plurality of vibration monitoring systems 100 connected to the rotating drum of a mineral crusher, and more particularly to respective ones of the plurality of elongated bolts 110 of the rotating mill 10, according to an embodiment of the present disclosure. In some embodiments, the plurality of vibration monitoring systems may be implemented as a plurality of audio monitoring systems. FIG. 6 shows a cross-section of the rotating drum 14 taken along line A-A on FIG. 1. In the non-limiting example of FIG. 6, three lifters 20 are distributed along a length of a horizontal section 14b of the rotating drum 14 and each lifter 20 is maintained in place using two or three elongated bolts 110, without using any conventional bolt 26. Eight systems 100 are connected via a common signaling wire 122 and a common electric wire 202 to the power supply 150 and to the controller 200. Other configurations are also contemplated. For example, additional lifters 20 are mounted on a section 14f of the rotating drum 14, where the material to be crushed is directly received from the feed end 12, and on a section 14d of the drum rotating 14 leading to the discharge end 18, where crushed material is discharged from the SAG mill 10. Systems 100 may be mounted on any one of the lifters 20 on the sections 14f and/or 14d of the rotating drum 14. Systems 100 may be directly mounted on any one of the elongated bolts 110 associated with the lifters 20. Historical information about operational parameters of a given SAG mill 10 and about a type of material being crushed in the SAG mill 10 may be used to select a number, location and disposition of the systems 100 within the rotating drum 14.

### Assembly Method

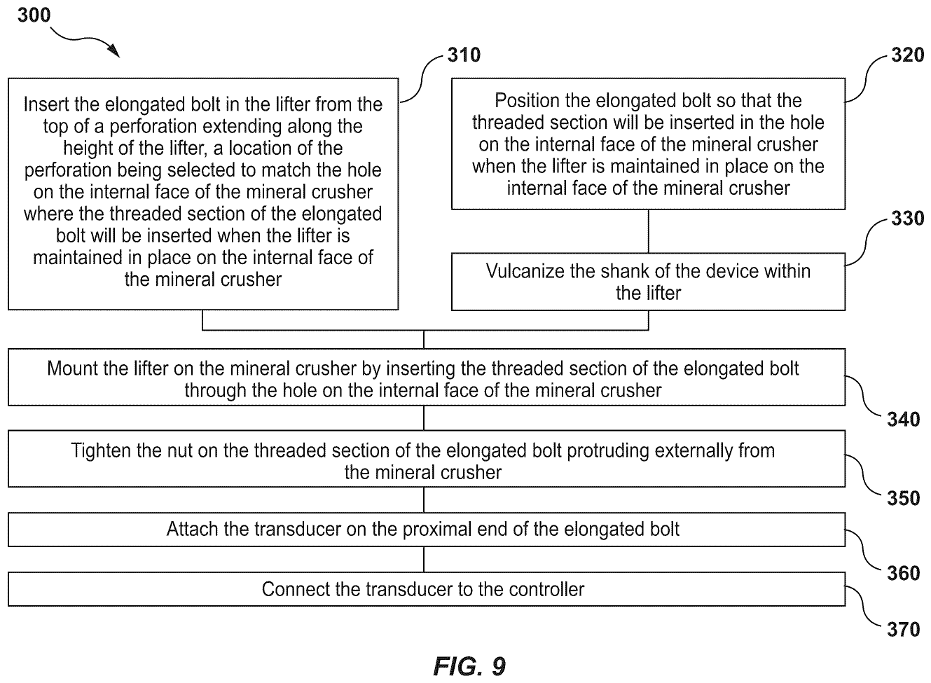

FIG. 9 is a sequence diagram showing operations of a method of assembling the wear monitoring device on the mineral crusher according to an embodiment of the present disclosure. On FIG. 9, a sequence 300 comprises a plurality of operations, some of which may be executed in variable order, some of the operations possibly being executed concurrently, some of the operations being optional. The elongated bolt 110 is first mounted to the lifter 20. If the lifter 20 is a steel lifter, mounting the elongated bolt 110 to the lifter 20 comprises inserting the elongated bolt 110 from a top of the perforation 46 that extends along the height of the lifter 20 at operation 310. A location of the perforation 46 has been selected to match the hole 30 on the internal face of the SAG mill 10 where the threaded section 112 of the elongated bolt 110 will be inserted when the lifter 20 is maintained in place on the internal face of the SAG mill 10. If the lifter 20 is a rubber lifter or a hybrid lifter, mounting the elongated bolt 110 to the lifter 20 comprises positioning the elongated bolt 110 at operation 320 so that its threaded section 112 will be inserted in the hole 30 of the internal face of the SAG mill 10 when the lifter 20 is maintained in place on the internal face of the SAG mill 10, and vulcanizing the shank 116 of the elongated bolt 110 within the lifter 20 at operation 330.

In any case, the lifter 20 with the attached elongated bolt 110 is then installed on the SAG mill 10 at operation 340 by inserting the threaded section 112 of the elongated bolt 110 through the hole 30 on the internal face of the SAG mill 10. At operation 350, the nut 30 is tightened on the threaded section 112 of the elongated bolt 110, the threaded section 112 being at the time protruding externally from the SAG mill 10. After tightening of the nut, the acoustic sensor 115 is attached directly on the proximal end 114 of the elongated bolt 110 at operation 360. The acoustic sensor 115 is connected to the controller 200, via the signaling wire 122 at operation 370.

Various operations of the sequence 300 may be configured to be processed by one or more processors, the one or more processors being coupled to one or more memory devices, including for example the processor 210 and the memory device 220 illustrated on FIG. 8.

Those of ordinary skill in the art will realize that the description of the device and of the system for monitoring wear of lifters mounted in a mineral crusher, and of the method of assembling the device on the mineral crusher are illustrative only and are not intended to be in any way limiting. Other embodiments will readily suggest themselves to such persons with ordinary skill in the art having the benefit of the present disclosure. Furthermore, the disclosed device, system and method may be customized to offer valuable solutions to existing needs and problems related to the fragility and the lack of precision of conventional measurement techniques for wear on lifters. In the interest of clarity, not all of the routine features of the implementations of the device, system and method are shown and described. In particular, combinations of features are not limited to those presented in the foregoing description as combinations of elements listed in the appended claims form an integral part of the present disclosure. It will, of course, be appreciated that in the development of any such actual implementation of the device, system and method, numerous implementation-specific decisions may need to be made in order to achieve the developer's specific goals, such as compliance with application-related, system-related, and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of non destructive testing having the benefit of the present disclosure.

In accordance with the present disclosure, the components, process operations, and/or data structures described herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a method comprising a series of operations is implemented by a computer, a processor operatively connected to a memory device, or a machine, those operations may be stored as a series of instructions readable by the machine, processor or computer, and may be stored on a non-transitory, tangible medium.

Systems and modules described herein may comprise software, firmware, hardware, or any combination(s) of software, firmware, or hardware suitable for the purposes described herein. Software and other modules may be executed by a processor and reside on a memory device of servers, workstations, personal computers, computerized tablets, personal digital assistants (PDA), and other devices suitable for the purposes described herein. Software and other modules may be accessible via a local memory device, via a network, via a browser or other application or via other means suitable for the purposes described herein. Data structures described herein may comprise computer files, variables, programming arrays, programming structures, or any electronic information storage schemes or method, or any combinations thereof, suitable for the purposes described herein.

The present disclosure has been described in the foregoing specification by means of non-restrictive illustrative embodiments provided as examples. These illustrative embodiments may be modified at will. The scope of the claims should not be limited by the embodiments set forth in the examples, but should be given the broadest interpretation consistent with the description as a whole.

What is claimed is:

1. A mill comprising:
a rotary drum having an outer surface and inner surface, the inner surface defining an internal cavity of the rotary drum;
a motor drivingly engaged with the rotary drum for causing the rotary drum to rotate;
a lifter located in the internal cavity of the rotary drum for promoting breakdown of mineral in the internal cavity; and
an acoustic condition monitoring system comprising:
an elongated bolt configured to selectively connect the lifter to the inner surface of the rotary drum, one end of the elongated bolt, flush to a top grinding surface of the lifter, located in the internal cavity of the rotary drum, an other end of the elongated bolt located outside of the rotary drum;
an acoustic sensor acoustically coupled to the elongated bolt for capturing acoustic waves carried by the bolt from an inside to an outside of the internal cavity, the signal being indicative of sound emanating from the inner cavity of the rotary drum, instead of from an outside environment of the rotary drum; and
a battery powered wireless monitoring system that communicates acoustic data generated to a mill operator or a mill operating control system.

2. The mill of claim 1, wherein the acoustic sensor is an audio sensor such as a microphone embedded within the elongated bolt.

3. The mill of claim 1, wherein the acoustic sensor is an acoustic emission (AE) sensor.

4. The mill of claim 1, wherein the bolt is elongated to become flush with the top grinding surface of the lifter manufactured by additive manufacturing, where in the elongated bolt possesses suitable mechanical properties to match the hardness of the lifter and strength.

5. The mill of claim 1, wherein the acoustic sensor is directly connected to the other end of the elongated bolt located outside of the rotary drum or located inside the elongated bolt.

6. The mill of claim 1, wherein the acoustic sensor detects number of metal-on-metal impacts of a grinding media on the elongated bolt and the acoustic signal frequency of such impacts, estimates a residual height of the lifter after calibration.

7. The mill of claim 1, wherein a signal amplitude of the waves provides information on the position of the charge within the revolving mill.

8. The mill of claim 1, wherein the mill comprises a plurality of lifters, and a plurality of acoustic monitoring systems associated with respective ones from the plurality of lifters.

9. The mill of claim 1, further comprising an on-board power generation module to provide continuous charging of the system.

10. A method of controlling operation of a mill, the method comprising:
acquiring a signal by an acoustic sensor connected directly to an elongated bolt, the elongated bolt connecting a lifter of the mill to an inner surface of a rotary drum of the mill;
providing the signal to a Machine Learning Algorithm (MLA), the MLA being configured to predict one or more operational parameters of the mill based on the signal, the signal being indicative of sound emanating from an inner cavity of the rotary drum, instead of from an outside environment of the rotary drum;
outputting by the MLA the one or more operational parameters of the mill; and
triggering one or more actions based on the one or more operational parameters of the mill.

11. The method of claim 10, wherein the MLA is configured to learn an optimum sound condition of the mill, for correlating speed of the mill with through put and lifter residual heights.

12. The method of claim 10, wherein the optimum sound condition of the mill depends on at least one of a mill weight, rates of ore input, amount and type of media input, amount of water input.

13. The method of claim 10, wherein the one or more operational parameters include charge position such as toe position and shoulder position.

14. The method of claim 10, wherein the one or more actions include displaying the one or more operational parameters to an operator of the mill.

15. The method of claim 14, wherein the displaying is performed periodically, one or multiple times per day.

16. The method of claim 10, wherein the one or more operational parameters include a lifter malfunction/breaking.

17. The method of claim 10, wherein the method further comprises:
determining a residual length of the elongated bolt using an electromagnetic acoustic transducer (EMAT) or an ultrasonic transducer (UT)
providing the residual length of the elongated bolt to the MLA; and
outputting the one or more operational parameters further based on the residual length of the elongated bolt equal to the residual height of the lifter.
